(19) United States
(12) Patent Application Publication
(10) Pub. No.: US 2025/0392110 A1
(43) Pub. Date: Dec. 25, 2025

(54) BI-METALLIC ALL-ALUMINUM REDUCING BUTT SPLICE

(71) Applicant: SHOALS TECHNOLOGIES GROUP, LLC, Portland, TN (US)

(72) Inventors: David L. Schardt, Portland, TN (US); Troy W. Renken, Portland, TN (US)

(21) Appl. No.: 19/076,856

(22) Filed: Mar. 11, 2025

Related U.S. Application Data
(60) Provisional application No. 63/661,822, filed on Jun. 19, 2024.

(51) Int. Cl. H02G 15/08

(52) U.S. Cl. CPC H02G 15/08

(57) ABSTRACT

In an example embodiment, a butt splice includes a body having a first end and a second end. The body is made entirely of aluminum or an aluminum alloy. The first end defines a cylindrical cavity having a first inner diameter and configured to receive therein an end of an aluminum wire. The second end defines a cylindrical cavity having a second inner diameter that is smaller than the first inner diameter and configured to receive therein an end of a copper wire. After crimping each end of the butt splice onto an exposed conductive core of the corresponding aluminum or copper wire, the butt splice may be encapsulated and hermetically sealed within a mold structure. The mold structure may include an overmold, or both an undermold and an overmold.

### CROSS-REFERENCE TO RELATED APPLICATION

This application claims the benefit of and priority to U.S. Provisional Patent Application No. 63/661,822 filed on Jun. 19, 2024. The 63/661,822 application is incorporated herein by reference in its entirety.

### FIELD

Embodiments described herein relate to a bi-metallic all-aluminum reducing butt splice.

### BACKGROUND

Unless otherwise indicated in the present disclosure, the materials described in the present disclosure are not prior art to the claims in the present application and are not admitted to be prior art by inclusion in this section.

Jumpers may be used in photovoltaic (PV) applications to connect two components with connectors. For example, a typical use involves using a jumper to connect strings of PV modules between two rows in an array of PV modules where each string has a connector (e.g., a pre-installed pigtail), or using a jumper to connect a string to a combiner box where both the string and the combiner box has a connector (e.g., a pre-installed pigtail).

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Some embodiments of the present disclosure include a jumper with a longer section of aluminum wire between two shorter sections of copper wire. Each copper wire may be coupled to a corresponding end of the aluminum wire using a bi-metallic all-aluminum reducing butt splice. Each butt splice may be hermetically sealed within a mold structure to prevent galvanic corrosion where the copper wire contacts the all-aluminum butt splice. The all-aluminum reducing butt splice and mold structure may be cheaper than an aluminum-copper butt splice in which aluminum and copper are friction welded together.

In an example, a butt splice includes a body having a first end and a second end. The body is made entirely of aluminum. As used herein, the term “aluminum” includes pure aluminum as well as alloys in which aluminum is the predominant metal. The first end defines a cylindrical cavity having a first inner diameter and configured to receive therein an end of an aluminum wire. The second end defines a cylindrical cavity having a second inner diameter that is smaller than the first inner diameter and configured to receive therein an end of a copper wire. As used herein, the term “copper” includes pure copper as well as alloys in which copper is the predominant metal.

In another example, a jumper includes an aluminum wire, a copper wire, and a butt splice. The aluminum wire has a first gauge or size. The copper wire has a second gauge or size that is smaller than the first gauge or size. The butt splice electrically and mechanically couples the aluminum wire and the copper wire together. The butt split includes a body having a first end and a second end. The body is made entirely of aluminum or an aluminum alloy. The first end defines a first cylindrical cavity having a first inner diameter and configured to receive therein an end of the aluminum wire. The second end defines a second cylindrical cavity having a second inner diameter that is smaller than the first inner diameter and configured to receive therein an end of the copper wire.

In another example, a method includes inserting an exposed conductive core of an aluminum wire having a first gauge or size into a first cavity defined in an aluminum or aluminum alloy first end of a butt splice. The method includes crimping the first end of the butt splice onto the exposed conductive core of the aluminum wire. The method includes inserting an exposed conductive core of a copper wire having a second gauge or size that is smaller than the first gauge or size into a second cavity defined in an aluminum or aluminum alloy second end of the butt splice. The second cavity of the second end of the butt splice has a smaller inner diameter than the first cavity of the first end of the butt splice. The method includes crimping the second end of the butt splice onto the exposed conductive core of the copper wire.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example operating environment in which a bi-metallic all-aluminum reducing butt splice may be implemented;

FIG. 2 illustrates an example jumper that may include a bi-metallic all-aluminum reducing butt splice;

FIGS. 3A and 3B are cross-sectional views of example butt splices that may be implemented in the jumper of FIG. 2;

FIGS. 4A and 4B include cross-sectional views of an example aluminum wire and copper wire butt coupled by the butt splice of FIG. 3A; and

FIGS. 5A and 5B include cross-sectional views of an example aluminum wire and copper wire butt coupled by the butt splice of FIG. 3B, all according to at least one embodiment described in the present disclosure.

### DESCRIPTION OF EMBODIMENTS

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

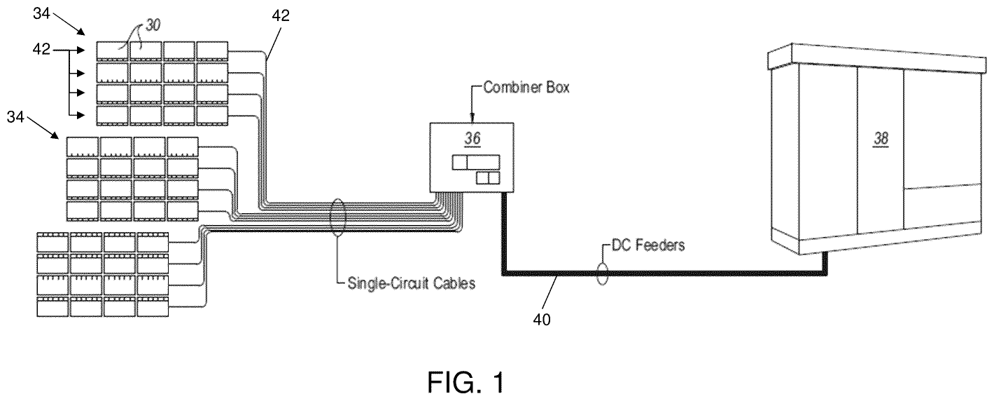

FIG. 1 illustrates an example operating environment 100 in which a bi-metallic all-aluminum reducing butt splice may be implemented, arranged in accordance with at least one embodiment herein. While discussed in the context of a PV system or environment, embodiments herein may be implemented in any other desired environment.

The environment 100 includes one or more arrays 34 of PV modules (or solar panels) 30 electrically coupled to a central combiner box 36, which in turn (along with one or more other combiner boxes 36 not depicted in FIG. 1) may be coupled to an inverter 38 through DC feeders 40. Each array 34 includes multiple rows 42 of PV modules 30. Each row 42 is coupled to the combiner box 36 via a jumper 42. Only some of, e.g., the arrays 34, the rows 42, and the jumpers 42 are labeled in FIG. 1 for simplicity. As described elsewhere herein, each of the jumpers 42 may couple to, e.g., a connector of a string/row 42 of PV modules 30 at one end and a connector of the combiner box 36 at the other end. Alternatively or additionally, the jumpers 42 may be used in other environments and/or locations than depicted in FIG. 1.

Some jumpers 42 include, exclusively or primarily, copper wire to conduct electricity from one end to the other. However, copper wire is relatively expensive and can significantly increase the cost of a PV system.

Embodiments of the jumpers 42 herein include aluminum wire along most of the length of the jumper 42 with a relatively short segment of copper wire at each end of the aluminum wire. However, since aluminum is less conductive than copper, the aluminum wire may be a larger gauge than the copper wire to compensate (partially or completely) for its poorer conductivity. Even so, jumpers 42 herein that use aluminum along most of their length may be significantly less expensive than purely copper jumpers of equal length given the significant cost difference between copper and aluminum.

In some embodiments, the aluminum wire may be 2 or 3 wire sizes larger than the copper wire to achieve lower resistance and, therefore, lower voltage drop than the copper wire. Aluminum wire that is 2 or 3 wire sizes larger than the copper wire may still be less expensive per length than copper wire, despite using more aluminum than a wire that is only, e.g., 1 wire size larger than the copper wire. Thus, the use of aluminum wire in a jumper may reduce cost compared to copper wire even if multiple wire sizes larger than the copper wire, and may optionally be sufficiently larger than the copper wire to additionally reduce the voltage drop per length compared to smaller gauge copper wire.

Some jumpers herein may be long enough to extend from one tracker to another tracker in a same row of photovoltaic modules. In this and other embodiments, a jumper may include another section of copper wire between trackers. For example, an embodiment of a jumper may include two aluminum wire sections interposed between three copper wire sections with four bi-metallic all-aluminum reducing butt splices for each copper-to-aluminum and aluminum-to-copper transition (i.e., one butt splice for each transition). In particular, such a jumper may include, in order, a first connector, a first copper wire section, a first butt splice, a first aluminum wire section, a second butt splice, a second copper wire section, a third butt splice, a second aluminum wire section, a fourth butt splice, a third copper wire section, and second connector. The middle copper wire section may be desirable between trackers for wire flexibility since the trackers may move independently of each other.

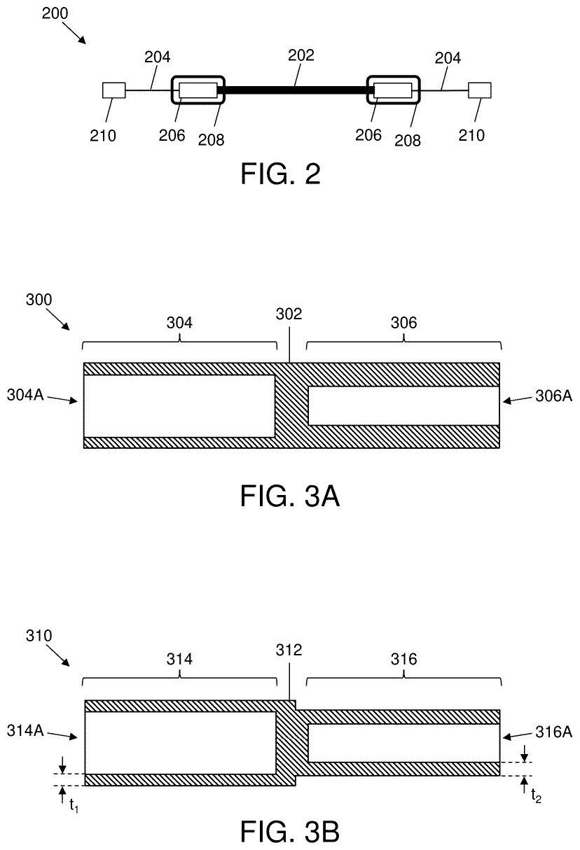

FIG. 2 illustrates an example jumper 200 that includes a bi-metallic all-aluminum reducing butt splice, arranged in accordance with at least one embodiment herein. The jumper 200 may include, be included in, or otherwise correspond to any or all of the jumpers 42 of FIG. 1.

In the illustrated example, the jumper 200 includes an aluminum wire 202 and two copper wires 204 coupled to opposing ends of the aluminum wire 202. The jumper 200 may have any suitable length, such as greater than 70 feet long, greater than 80 feet long, greater than 90 feet long, greater than 100 feet long, or even longer (e.g., hundreds of feet long). As indicated above, the aluminum wire 202 may extend along most of a length of the jumper 200 while the copper wire 204 at each end of the aluminum wire 202 may be in relatively short segments. For example, the aluminum wire 202 may be greater than 50 feet long, greater than 60 feet long, greater than 70 feet long, greater than 80 feet long, or even longer. Alternatively or additionally, each copper wire 204 may be less than 6 feet long, less than 5 feet long, less than 4 feet long, less than 3 feet long, or even shorter. In general, each wire 202, 204 may include an electrically conductive core surrounded by an insulative jacket or layer.

In some embodiments, the copper wire 204 is a first gauge or size while the aluminum wire 202 is a second gauge or size that is larger than the first gauge. For example, the copper wire 204 may be 6 AWG, 8 AWG, 10 AWG, 12 AWG, or other size, while the aluminum wire 202 may be a larger size such as 2 AWG, 4 AWG, or 6 AWG. Alternatively or additionally, the copper wire 204 may have a cross-sectional area of about 16 millimeters squared (mm²), about 10 mm², about 6 mm², or about 4 mm² while the aluminum wire 202 may have a larger cross-sectional area of about 35 mm², about 25 mm², or about 16 mm².

The jumper 200 additionally includes butt splices 206 that butt couple the aluminum wire 202 to each of the copper wires 204. In general, each butt splice 206 has opposing ends or sides, where one end or side receives therein an end of the aluminum wire 202 and the other end or side receives therein an end of a corresponding one of the copper wires 204. Some or all of the end of the wire 202, 204 may be stripped of its insulative jacket before being inserted into and crimped in the corresponding end of the butt splice 206 so that the butt splice 206 may be electrically coupled to the corresponding wire 202, 204.

In some embodiments, each butt splice 206 is a bi-metallic all-aluminum reducing butt splice. Each butt splice 206 may be bi-metallic in the sense that it couples a wire of one metal (e.g., copper wire 204) to a wire of another metal (e.g., aluminum wire 202).

Each butt splice 206 may be “all-aluminum” in the sense that it may be made entirely or primarily of aluminum, such as an aluminum alloy, tinned aluminum, or the like. For example, both a first end of the butt splice 206 that receives an end of the aluminum wire 202 and a second end of the butt splice 206 that receives an end of the copper wire 204 may be made of the same aluminum. An all-aluminum reducing butt splice may be less expensive than copper-aluminum reducing butt splices (i.e., butt splices that have one end of copper and another end of aluminum) since aluminum is cheaper than copper. Butt splices herein may also be less expensive for coupling two wires of disparate materials (e.g., copper and aluminum, such as wires 204, 202) together than other coupling structures or methods like friction welding and also involve lower capital equipment cost (e.g., no friction welder). As such, the all-aluminum butt splices 206 herein may provide significant cost savings compared to copper-aluminum butt splices and/or friction welding or other joining methods.

Each butt splice 206 may be a reducing butt splice in that it couples a relatively larger wire (e.g., the aluminum wire 202) to a relatively smaller wire (e.g., the copper wires 204).

FIG. 2 further illustrates connectors 210 coupled to ends of the copper wires 204. Such connectors 210 may include MC4 connectors or other suitable connectors.

In use, each butt splice 206 may be used in a compression crimping operation on both the copper wires 204 and the aluminum wire 202. In particular, an end of a given wire (e.g., either of the copper wires 204 or the aluminum wire 202) may be inserted into a corresponding end of the corresponding butt splice 206 and the corresponding end of the corresponding butt splice 206 may then be crimped to both mechanically and electrically couple the butt splice 206 to the end of the corresponding wire. The end of the given wire may be stripped of its insulative jacket before being inserted into the corresponding end of the corresponding butt splice 206.

To prevent galvanic corrosion between the butt splices 206 and the copper wires 204, each butt splice 206 and a portion of the copper wire 204 and/or aluminum wire 202 extending therefrom may be hermetically sealed against the environment. In some embodiments, the hermetic seal is provided by encapsulating or covering each butt splice 206 (and the portions of the wires 204, 202) within one or more mold structures 208. One or more of the mold structures 208 may each include a single mold structure such as an overmold that encapsulates or covers the butt splice 206. Alternatively or additionally, one or more of the mold structures 208 may each include multiple mold structures such as an undermold structure that encapsulates or covers the butt splice 206 as well as an overmold structure that encapsulates or covers the undermold structure. Example mold structures and related details are disclosed in U.S. Pat. No. 10,992,254, which is incorporated herein by reference in its entirety.

Other solutions for butt coupling a copper wire and an aluminum wire include copper-aluminum butt splices that include one end of copper and one end of aluminum. The two ends of disparate metals are joined together by a friction welding process which prevents galvanic corrosion due to the nature of the copper-aluminum joint in the friction welded butt splice. The copper wire is then received into and crimped in the copper side of the butt splice while the aluminum wire is received into and crimped in the aluminum side of the butt splice. Due to the absence of galvanic corrosion, no hermetic seal is necessary with copper-aluminum butt splices. However, such copper-aluminum butt splices for joining copper and aluminum wires are more costly than all-aluminum butt splices as described herein due to the higher materials cost (for copper) and the higher cost of friction welding (both in terms of the process and the equipment).

FIGS. 3A and 3B are cross-sectional views of example butt splices 300, 310 that may be implemented in the jumper 200 of FIG. 2 or other jumpers, arranged in accordance with at least one embodiment herein. Each butt splice 300, 310 may include, be included in, or otherwise correspond to any of the butt splices 206 of FIG. 2 or other butt splices herein. As illustrated, each of the butt splices 300, 310 includes a body 302, 312 of aluminum (e.g., aluminum alloy, tinned aluminum, or the like) as well as a first end 304, 314 and a second end 306, 316.

The first end 304, 314 of each butt splice 300, 310 includes a first cavity 304A, 314A formed in the body 302, 312. The first cavity 304A, 314A may be configured to receive therein an end of an aluminum wire (e.g., after removal of its insulative jacket), such as an end of the aluminum wire 202 of FIG. 2.

The second end 306, 316 of each butt splice 300, 310 includes a second cavity 306A, 316A formed in the body 302, 312. The second cavity 306A, 316A may be configured to receive therein an end of a copper wire with a smaller gauge or size than the aluminum wire received in the first cavity 304A, 314A (e.g., after removal of its insulative jacket), such as an end of the copper wire 204 of FIG. 2.

In some embodiments, the first cavity 304A, 314A has an inner diameter equal to or slightly larger than (e.g., 5%, 10%, or 15% larger than) a diameter of an aluminum wire configured to be received therein, which in some embodiments herein may include a wire of size 2 AWG, 4 AWG, 6 AWG, or other size. The second cavity 306A, 316A may have an inner diameter equal to or slightly larger than (e.g., 5%, 10%, or 15% larger than) a diameter of a copper wire configured to be received therein, which in some embodiments herein may include a wire of size 6 AWG, 8 AWG, 10 AWG, 12 AWG, or other size. Embodiments herein include butt splices 300, 310 with first ends 304, 314 and second ends 306, 316 having any combination of two inner diameters where the first end 304, 314 has a larger inner diameter to receive aluminum wire while the second end 306, 316 has a smaller inner diameter to receive copper wire.

In some embodiments herein, each of the butt splices 300, 310 is manufactured as a single rod or body 302, 312 of aluminum (e.g., aluminum alloy, tinned aluminum, or the like) and has a grade that may be selected or optimized for PV wire compression. The single piece of aluminum may be drilled at each of the first end 304, 314 and the second end 306, 316 or otherwise processed to form the cavities 304A, 314A, 306A, 316A at the opposing ends 304, 314, 306, 316 thereof where each cavity 304A, 314A, 306A, 316A has a corresponding inner diameter to crimp different wire gauges of either aluminum or copper wire.

In the example of FIG. 3A, the butt splice 300 may have a constant or substantially constant outer diameter along its length. In FIG. 3B, an outer diameter of the second end 316 may be turned down to a smaller outer diameter or may otherwise be formed with a smaller outer diameter than the first end 314, e.g., for crimp optimization. For example, the second end 316 may be processed (turned down or the like) so that its radial thickness t₂ is equal or approximately equal to a radial thickness t₁ of the first end 314. In these and other embodiments, the entire butt splice 300, 310 may be tinned which may allow it to be compatible with both aluminum and copper wire.

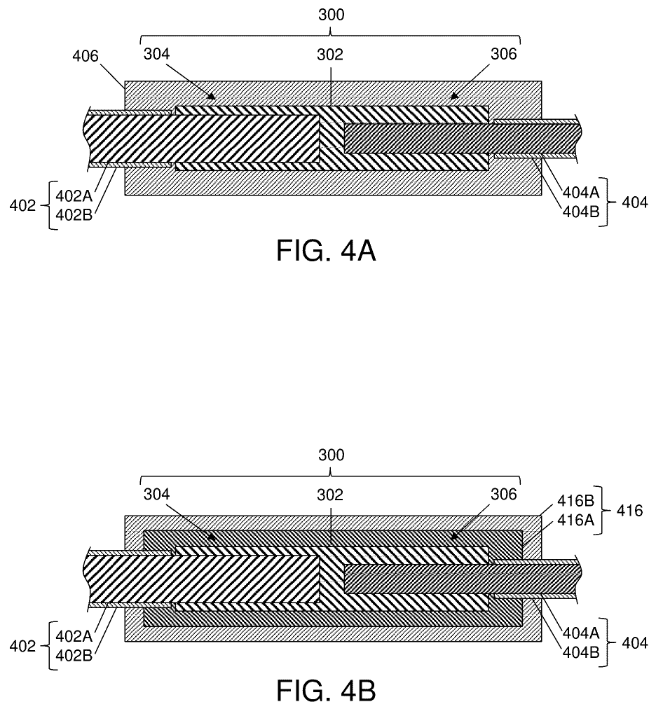

FIGS. 4A and 4B include cross-sectional views of an example aluminum wire 402 and copper wire 404 butt coupled by the butt splice 300 of FIG. 3A, arranged in accordance with at least one embodiment herein. The aluminum wire 402 includes both a conductive core 402A made of aluminum and an insulative jacket or layer 402B that surrounds the core 402A. Similarly, the copper wire 404 includes both a conductive core 404A made of copper and an insulative jacket or layer 404B that surrounds the core 404A.

The insulative jacket 402B, 404B may be removed from an end of the corresponding wire 402, 404 to expose the corresponding core 402A, 404A. The exposed core 402A, 404A may then be inserted into the corresponding cavity 304A, 306A (FIG. 3A) in the corresponding end 304, 306 of the butt splice 300, followed by crimping the end 304, 306 of the butt splice 300 onto the end of the corresponding wire 402, 404.

FIGS. 4A and 4B additionally illustrate a mold structure 406, 416 that may be molded over the butt splice 300 to encapsulate and hermetically seal the butt splice 300 against the environment to prevent galvanic corrosion, particularly where the end 306 of the butt splice 300, which is made of aluminum, couples to the exposed end of the core 404B of the copper wire 404. The mold structure 406, 416 additionally extends over portions of the insulative jackets 402B, 404B of the wires 402, 404.

In the example of FIG. 4A, the mold structure 406 includes an overmold that encapsulates and hermetically seals the butt splice 300. The overmold of the mold structure 406 additionally extends over portions of the insulative jackets 402B, 404B and may encapsulate these portions of the insulative jackets 402B, 404B.

In the example of FIG. 4B, the mold structure 416 includes an undermold 416A that encapsulates and hermetically seals the butt splice 300. The undermold 416A of the mold structure 416 additionally extends over portions of the insulative jackets 402B, 404B and may encapsulate these portions of the insulative jackets 402B, 404B. The mold structure 416 additionally includes an overmold 416B that encapsulates and hermetically seals the undermold. The overmold 416B of the mold structure 416 additionally extends over portions of the insulative jackets 402B, 404B and may encapsulate these portions of the insulative jackets 402B, 404B.

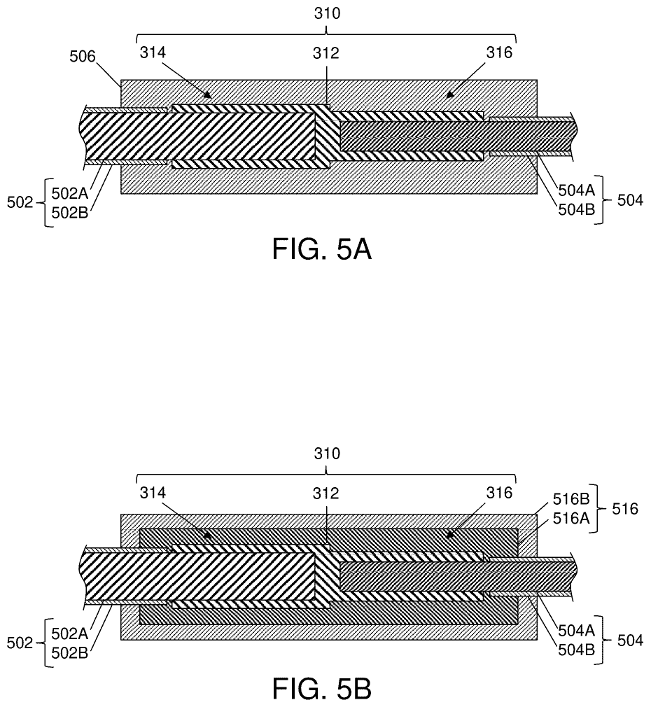

FIGS. 5A and 5B include cross-sectional views of an example aluminum wire 502 and copper wire 504 butt coupled by the butt splice 310 of FIG. 3B, arranged in accordance with at least one embodiment herein. The aluminum wire 502 includes both a conductive core 502A made of aluminum or aluminum alloy and an insulative jacket or layer 502B that surrounds the core 502A. Similarly, the copper wire 504 includes both a conductive core 504A made of copper or copper alloy and an insulative jacket or layer 504B that surrounds the core 504A.

The insulative jacket 502B, 504B may be removed from an end of the corresponding wire 502, 504 to expose the corresponding core 502A, 504A. The exposed core 502A, 504A may then be inserted into the corresponding cavity 314A, 316A (FIG. 3A) in the corresponding end 314, 316 of the butt splice 310, followed by crimping the end 314, 316 of the butt splice 310 onto the end of the corresponding wire 502, 504.

FIGS. 5A and 5B additionally illustrate a mold structure 506, 516 that may be molded over the butt splice 310 to encapsulate and hermetically seal the butt splice 310 against the environment to prevent galvanic corrosion, particularly where the end 316 of the butt splice 310, which is made of aluminum, couples to the exposed end of the core 504B of the copper wire 504. The mold structure 506, 516 additionally extends over portions of the insulative jackets 502B, 504B of the wires 502, 504.

In the example of FIG. 5A, the mold structure 506 includes an overmold that encapsulates and hermetically seals the butt splice 310. The overmold of the mold structure 506 additionally extends over portions of the insulative jackets 502B, 504B and may encapsulate these portions of the insulative jackets 502B, 504B.

In the example of FIG. 5B, the mold structure 516 includes an undermold 516A that encapsulates and hermetically seals the butt splice 310. The undermold 516A of the mold structure 516 additionally extends over portions of the insulative jackets 502B, 504B and may encapsulate these portions of the insulative jackets 502B, 504B. The mold structure 516 additionally includes an overmold 516B that encapsulates and hermetically seals the undermold. The overmold 516B of the mold structure 516 additionally extends over portions of the insulative jackets 502B, 504B and may encapsulate these portions of the insulative jackets 502B, 504B.

In FIGS. 4A-5B, the mold structure 406, 506 and/or the overmold 416B, 516B may include any suitable thermoplastic compound or other material that has been applied by injection molding or other suitable process. In the examples of FIGS. 4B and 5B, the overmold 416B, 516B may be applied in a second injection molding processor or other process, e.g., following application of undermold 416A, 516A. Alternatively or additionally, in FIGS. 4B and 5B, the undermold 416A, 516A may include any suitable thermoplastic compound or other material that has been applied by injection molding or other suitable process. In FIGS. 4A-5B, the mold structures 406, 416, 506, 516 may be durable, resistant to environmental factors such as temperature fluctuations, debris, and moisture, and may be strong enough to be buried.

Jumpers, such as the jumper 200 of FIG. 2, implemented with an all aluminum (or aluminum alloy) butt splice (e.g., 300, 310) and mold structure (e.g., 406, 416, 506, 516) as described herein may have one or more of the following specifications: Voltage rating of 600 VDC/1000 VDC/1500 VDC/2000 VDC/3000 VDC or more generally anywhere in the range 600-3000 VDC (or intervening ranges); branch current up to 30 amps per jumper or higher; overcurrent protection up to 30 amps per jumper or higher; and ambient operating temperature up to 50° C. or higher, although other embodiments beyond these specifications are within the scope of the claims.

An example assembly method of a jumper will now be described in the context of FIG. 2 with the understanding that each butt splice 206 and mold structure 208 may include any of the butt splices (e.g., 300, 310) and/or mold structures (e.g., 406, 416, 506, 516) described herein. In the example jumper assembly method, one instance of the butt splice 206 may be crimped onto a short copper lead, e.g., one of the copper wires 204 of FIG. 2, that has the connector 210 assembled on the other end to form a crimped copper subassembly. Alternatively, the connector 210 may be assembled onto the other end of the copper lead after the butt splice 206 is crimped onto the copper lead. The crimped copper subassembly (e.g., one each of the connector 210, the copper wire 204, and the butt splice 206) may then be crimped onto one end of the longer aluminum wire 202. Another instance of the butt splice 206 may be crimped onto another short copper lead, e.g., the other one of the copper wires 204 of FIG. 2, that has the other connector 210 assembled on the other end to form another crimped copper subassembly. Alternatively, the other connector 210 may be assembled onto the other end of the other copper lead 204 after the other butt splice 206 is crimped onto the other copper lead 204. The other crimped copper subassembly (e.g., one each of the other connector 210, the other copper wire 204, and the other butt splice 206) may then be crimped onto the other end of the longer aluminum wire 202. In another embodiment, the two butt splices 206 are crimped (in any order) onto opposite ends of the aluminum wire 202 before being crimped onto the copper wires 204 and then each of the two butt splices 206 is crimped onto a corresponding one of the copper wires 204 where the connectors 210 are assembled onto the copper wires 204 before or after crimping the butt splices 206 onto the copper wires 204. After the butt splices 206 are crimped onto the two copper wires 204 and opposite ends of the aluminum wire 202 (in any sequence or order), the completed assembly may then go through under-molding and/or over-molding operations to encapsulate each butt splice 206 within one or more mold structures 208 before going through a final quality check.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A butt splice, comprising:
a body having a first end and a second end;
wherein:
the body is made entirely of aluminum or an aluminum alloy;
the first end defines a cylindrical cavity having a first inner diameter and configured to receive therein an end of an aluminum wire; and
the second end defines a cylindrical cavity having a second inner diameter that is smaller than the first inner diameter and configured to receive therein an end of a copper wire.

2. The butt splice of claim 1, wherein at least one of:
the aluminum wire is a 6 AWG aluminum wire and the copper wire is an 8 AWG or 10 AWG copper wire;
the aluminum wire is a 4 AWG aluminum wire and the copper wire is a 6 AWG, an 8 AWG, or 10 AWG copper wire; or
the aluminum wire is a 2 AWG aluminum wire and the copper wire is a 6 AWG, an 8 AWG, or 10 AWG copper wire.

3. The butt splice of claim 1, wherein the butt splice is tinned.

4. The butt splice of claim 1, wherein an outer diameter of the second end of the butt splice is smaller than an outer diameter of the first end of the butt splice.

5. A jumper, comprising:
an aluminum wire having a first gauge or size;
a copper wire having a second gauge or size that is smaller than the first gauge or size; and
a butt splice to electrically and mechanically couple the aluminum wire and the copper wire together, the butt split comprising a body having a first end and a second end, wherein:
the body is made entirely of aluminum or an aluminum alloy;
the first end defines a first cylindrical cavity having a first inner diameter and configured to receive therein an end of the aluminum wire; and
the second end defines a second cylindrical cavity having a second inner diameter that is smaller than the first inner diameter and configured to receive therein an end of the copper wire.

6. The jumper of claim 5, further comprising a mold structure to encapsulate and hermetically seal the butt splice, a portion of the aluminum wire extending from the first end of the butt splice, and a portion of the copper wire extending from the second end of the butt splice.

7. The jumper of claim 6, wherein the mold structure comprises an overmold that encapsulates and hermetically seals the butt splice.

8. The jumper of claim 6, wherein the mold structure comprises an undermold that encapsulates and hermetically seals the butt splice and an overmold that encapsulates and hermetically seals the undermold.

9. The jumper of claim 5, wherein the aluminum wire is at least 30 feet in length.

10. The jumper of claim 5, wherein the copper wire is no longer than 5 feet in length.

11. The jumper of claim 5, wherein an end of the copper wire opposite to the end coupled to the butt splice has coupled thereto an MC4 connector.

12. The jumper of claim 5, wherein an outer diameter of the second end of the butt splice is smaller than an outer diameter of the first end of the butt splice.

13. The jumper of claim 5, wherein one of:
the aluminum wire is a 6 AWG aluminum wire and the copper wire is an 8 AWG or 10 AWG copper wire;
the aluminum wire is a 4 AWG aluminum wire and the copper wire is a 6 AWG, an 8 AWG, or 10 AWG copper wire; or
the aluminum wire is a 2 AWG aluminum wire and the copper wire is a 6 AWG, an 8 AWG, or 10 AWG copper wire.

14. A method, comprising:
inserting an exposed conductive core of an aluminum wire having a first gauge or size into a first cavity defined in an aluminum or aluminum alloy first end of a butt splice;
crimping the first end of the butt splice onto the exposed conductive core of the aluminum wire;
inserting an exposed conductive core of a copper wire having a second gauge or size that is smaller than the first gauge or size into a second cavity defined in an aluminum or aluminum alloy second end of the butt splice, the second cavity of the second end of the butt splice having a smaller inner diameter than the first cavity of the first end of the butt splice; and
crimping the second end of the butt splice onto the exposed conductive core of the copper wire.

15. The method of claim 14, further comprising forming a mold structure to encapsulate and hermetically seal the butt splice, a portion of the aluminum wire extending from the first end of the butt splice, and a portion of the copper wire extending from the second end of the butt splice.

16. The method of claim 15, wherein forming the mold structure includes injection molding the mold structure.

17. The method of claim 15, wherein forming the mold structure includes forming an overmold to encapsulate and hermetically seal the butt splice.

18. The method of claim 15, wherein forming the mold structure includes:
forming an undermold to encapsulate and hermetically seal the butt splice; and
forming an overmold to encapsulate and seal the undermold.

19. The method of claim 14, wherein crimping the first end of the butt splice onto the exposed conductive core of the aluminum wire happens after crimping the second end of the butt splice onto the exposed conductive core of the copper wire.

20. The method of claim 18, further comprising, prior to crimping the second end of the butt splice onto the exposed conductive core of the copper wire, assembling a connector onto an end of the copper wire that is opposite an end of the copper wire that includes the exposed conductive core of the copper wire.
